(19) United States
(12) Patent Application Publication
(10) Pub. No.: US 2011/0168732 A1
(43) Pub. Date: Jul. 14, 2011

(54) DISPENSER

(76) Inventors: Tony Antunes, Paris (FR); Emilie Beskar, Harleysville, PA (US); David Hemmerlin, Basel (CH); Aurele Hurtis, Paris (FR); Francis Lovell, Paris (FR)

(21) Appl. No.: 13/119,443

(22) PCT Filed: Sep. 17, 2009
(86) PCT No.: PCT/US09/57226

§ 371 Date: Mar. 17, 2011

Related U.S. Application Data
(60) Provisional application No. 61/097,993, filed on Sep. 18, 2008.

(30) Foreign Application Priority Data
Sep. 18, 2008 (EP) 08164658.0

(51) Int. Cl. B65D 83/04; B65G 59/00

(52) U.S. Cl. 221/1; 221/69

(57) ABSTRACT

A dispenser 1 for use with a medicament carrier 2. The medicament carrier 2 contains a at least one medicament product 8 which can be released therefrom. The dispenser 1 comprising a body 12, a collecting conduit 18 and a dispensing aperture 16. The body 12 includes a holding portion 14 for holding a medicament carrier 2. The holding portion 14 includes at least one inlet aperture 32 arranged to receive a medicament 8 released from a medicament carrier 2 held thereon. The collecting conduit 18 connects the at least one inlet aperture 32 and the at least one dispensing aperture 16. The dispenser 1 is configured such that a medicament 8 dispensed from a medicament carrier 2 thereon passes through the inlet aperture 32 and into the collecting conduit 18 from which it can be dispensed through the dispensing aperture 16.

The present application relates to a dispenser for dispensing a medicament from a medicament carrier, particularly to a dispenser for use with a blister pack type of medicament carrier.

Medicaments can be supplied in many types of packaging from which a user must remove or release the medicament before it can be used/taken.

A common medicament carrier is a blister pack which comprises a formed layer which is typically formed to include a plurality of blisters which are raised on one side and provide a cavity on the opposing side into which a medicament can be placed. The blisters are then sealed with a membrane, typically a foil, although other materials can be used. One way to access the medicament is for a user to apply a force to the raised blister so that the medicament is forced through the membrane and out of the carrier.

The releasing of medicaments from such a carrier can be difficult for users with limited dexterity and the medicament is not necessarily dispensed reliably into a desired location, for example the hand of a user.

The invention provides a dispenser for use with a medicament carrier, the medicament carrier containing at least one medicament product which can be released therefrom, the dispenser comprising a first member including a body, at least one second member comprising a dispensing aperture, the body including a holding portion for holding a medicament carrier, the holding portion including at least one inlet aperture arranged to receive a medicament released from a medicament carrier held thereon, the dispenser including a collecting conduit connecting the at least one inlet aperture and the at least one dispensing aperture, the dispenser configured such that a medicament dispensed from a medicament carrier thereon passes through the inlet aperture and into the collecting conduit from which it can be dispensed through the dispensing aperture, the first and at least one second member being slidably coupled to one another and movable between a closed configuration in which access to at least a portion of least one of the medicament carrier and dispensing aperture may be substantially hindered, or release of a medicament from the medicament carrier may be substantially hindered and a dispensing, or open, configuration, in which access to at least one of the medicament carrier and dispensing aperture or release of a medicament from the carrier is substantially not so hindered.

Providing a dispenser which includes a collecting conduit allows a user to release a medicament into the dispenser and then dispense the medicament from the dispensing aperture as desired. This provides a more convenient method of dispensing medicament, particularly if two or more medicaments are to be dispensed at one time as both can be collected in the collecting conduit and dispensed from the dispensing aperture as desired.

The medicament carrier can contain medicaments of many forms such as tablet, capsule, ampoule or other suitable medicament forms. The medicament may include an active compound suitable for treating a user, or may be formed to resemble such a medicament as a placebo for clinical trials

The medicament carrier may contain a single medicament, or may be adapted to contain a plurality of medicaments. If a plurality of medicaments are intended the medicament carrier may include a plurality of substantially identical medicaments, or may contain medicament of different types and/or forms.

In one embodiment a carrier may be contain a plurality of a single type of medicament. The dispenser may be adapted to include two or more holding portions which may each hold different carriers, or carriers which contain different medicaments, or one or more of the holding portion may include carriers which are substantially identical, or which contain substantially identical medicaments.

Although the dispenser is envisaged for use with various medicament carriers, it is particularly intended for use with blister pack type medicament carriers.

A blister pack type carrier comprises a formed layer which may comprise from a plastics material and/or a moisture barrier material. The formed layer is formed to include at least one blister which is raised on one side and provides a cavity on the opposing side of the formed layer. The cavity provides a location into which one or more medicaments can be placed. The blister is then sealed with a breakable membrane. The breakable membrane may be a foil, a foil and plastics laminate or other material, for example a paper membrane. To access the medicament a user applies a force, directly or indirectly using, for example a mechanical or electronic mechanism, to the raised blister which is deformed by the force and contacts the content, pressing it against the breakable membrane. When sufficient force is applied the membrane ruptures and the content is released from the medicament carrier.

The medicament carrier, for example a blister pack, may comprise a plurality of locations from which a medicament can be released, for example blisters. The plurality of locations may be arranged in a single line, a plurality of lines, a predetermined pattern, or other array.

In an embodiment in which a plurality of such locations are included the holding portion may include a plurality of inlet apertures. Each inlet aperture may be arranged to correspond with a single release location in a corresponding pattern, or a single inlet aperture may be arranged to correspond to a plurality of release locations.

In the closed configuration access to at least a portion of least one of the medicament carrier and dispensing aperture is substantially hindered, or release of a medicament from the medicament carrier is substantially hindered. In the open configuration access to at least one of the medicament carrier and dispensing aperture or release of a medicament from the carrier is substantially not so prevented. This can provide a child resistant feature as the dispenser must be moved to the open configuration before access to a medicament to be dispensed is not substantially hindered.

In such an embodiment the second member can act as a cover for the first member by substantially preventing access to portions of the first member.

The first and second members cooperate in at least the open configuration or the closed configuration to form the collecting conduit.

At least one inlet aperture in the holding portion may be substantially blocked by the second member when in the closed configuration as this would substantially prevent a medicament from being released into the collecting conduit.

The first member and at least one second member may be releasably secured together in the closed configuration by at least one releasable catch which must be released before the dispenser can be moved into the open configuration. This can provide a further child proof feature as a user must first release the catch and then move the dispenser into the open configuration.

The or each releasable catch may be releasable using a button associated with each catch. A single button may release a single catch or it may release more than one, or all the catches. The button may simply comprise a button region which is deformable upon application of a force by a user. The releasable catch may comprise a depression on one member and a corresponding protrusion on the other member which are arranged such that the in the closed position the protrusion is biased into the depression and a threshold force must be applied in order to move the protrusion from the depression and permit movement between the members without significant hindrance.

A medicament carrier may be releasably secured to the holding portion so that the blister pack can be replaced when it is empty and the dispenser can be reused or may be substantially permanently secured thereto.

The releasable securing may be by any suitable method, for example the blister pack can be slid into guide rails arranged in the holding portion, the blister pack may be held in place using a releasable adhesive, catches or other holding means.

If a blister pack is substantially permanently secured to the holding portion then an adhesive may be used, the carrier may be welded or otherwise bonded to the dispenser. The blister pack could be moulded in place or integrally moulded with the holding portion.

It should be understood that while the first and second members are described as members, they may be fabricated from a plurality of parts coupled together or a single part, for example from a single moulding.

The collecting conduit may include a collecting chamber within which a medicament can be temporarily stored before release through the dispensing aperture. This may be used if, for example, the dispensing aperture is not accessible when the dispenser is in the open configuration.

There are many arrangements of dispenser which are envisaged by this invention. In the closed configuration a user may be able to access the blisters, release a medicament and dispense the medicament, or one of more of these actions may be hindered. In the open configuration a user may be able to access the blisters, release a medicament and dispense the medicament, or one of more of these actions may be hindered. There are therefore many combinations of dispensing actions that can be envisaged, some of which may provide additional child resistance.

The invention also provides a medication kit comprising a dispenser and at least one medicament carrier, the medicament carrier containing at least one medicament and the dispenser being as described above.

The invention further provides a method for dispensing a medicament from a medicament carrier attached to a holding portion of a dispenser, the dispenser comprising a first member including a body, at least one second member comprising a dispensing aperture, the body including the holding portion for holding a medicament carrier, the holding portion including at least one inlet aperture arranged to receive a medicament released from a medicament carrier held thereon, the dispenser including a collecting conduit connecting the at least one inlet aperture and the at least one dispensing aperture, the method comprising the steps of:
a. arranging the dispenser in an open configuration so that at least a portion of the medicament carrier is accessible to a user;
b. applying a force to a portion of the medicament carrier to release a medicament from the medicament carrier so the medicament passes through an inlet aperture in the holding portion;
c. using the collecting conduit to catch and retain the medicament that passes through the inlet aperture;
d. arranging the dispenser into the closed configuration so that the collecting conduit is not blocked; and
e. manipulating the dispenser so that the medicament from the collecting conduit is dispensed from the dispensing aperture.

One or more of the steps of arranging the dispenser may comprise moving the dispenser between closed and open configurations depending upon the construction of the dispenser. One or more of the steps of arranging the dispenser may comprise changing the orientation of the dispenser so that a user can more easily see or access the relevant part. One or more of the steps of arranging the dispenser may simply comprise ensuring that the dispenser is already correctly configured and oriented.

It should be understood that throughout this specification and in the claims that follow, unless the context requires otherwise, the word “comprise”, or variations such as “comprises” or “comprising”, implies the inclusion of the stated integer or step, or group of integers or steps.

The invention will now be further described, by way of example only, with reference to the following drawings in which:

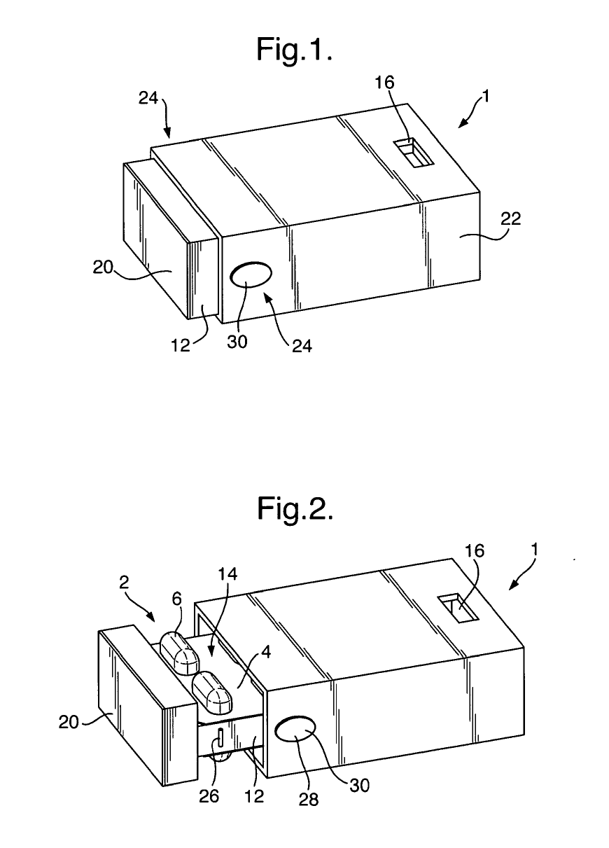

FIG. 1 shows an embodiment of a dispenser in a closed configuration;

FIG. 2 shows the dispenser of FIG. 1 in a partly open configuration;

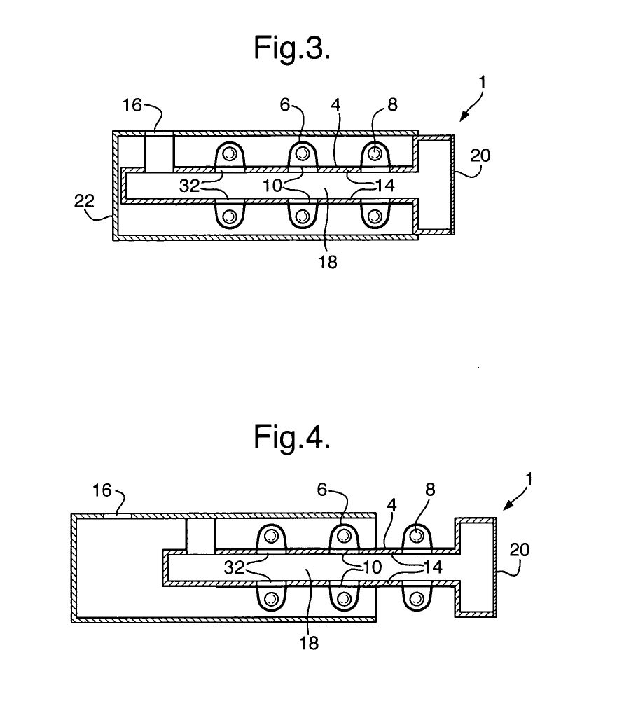

FIG. 3 shows a cross section through the dispenser of FIG. 1 in a closed configuration;

FIG. 4 shows a cross section through the dispenser of FIG. 1 in a partly open configuration;

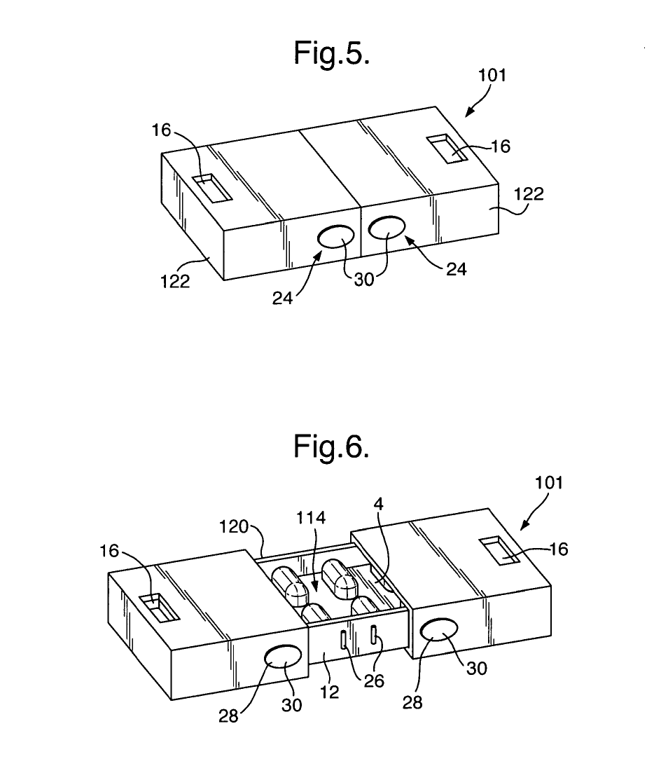

FIG. 5 shows a different embodiment of a dispenser in a closed configuration;

FIG. 6 shows the dispenser of FIG. 5 in a partly open configuration;

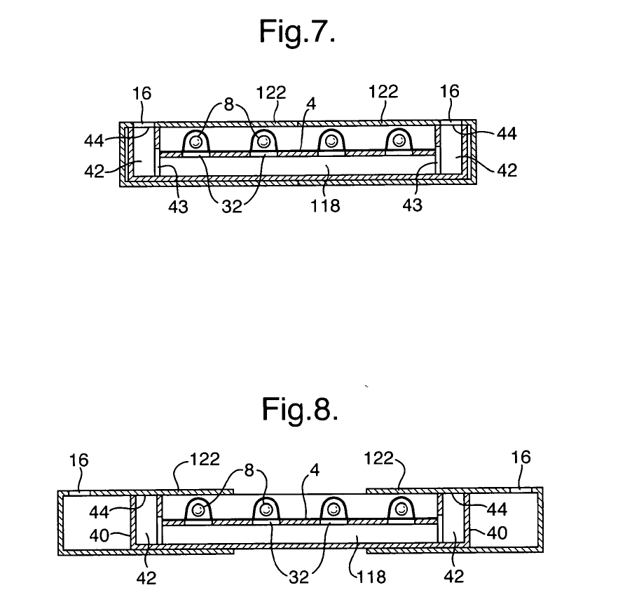

FIG. 7 shows a cross section through the dispenser of FIG. 5 in a closed configuration;

FIG. 8 shows a cross section through the dispenser of FIG. 6 in a partly open configuration;

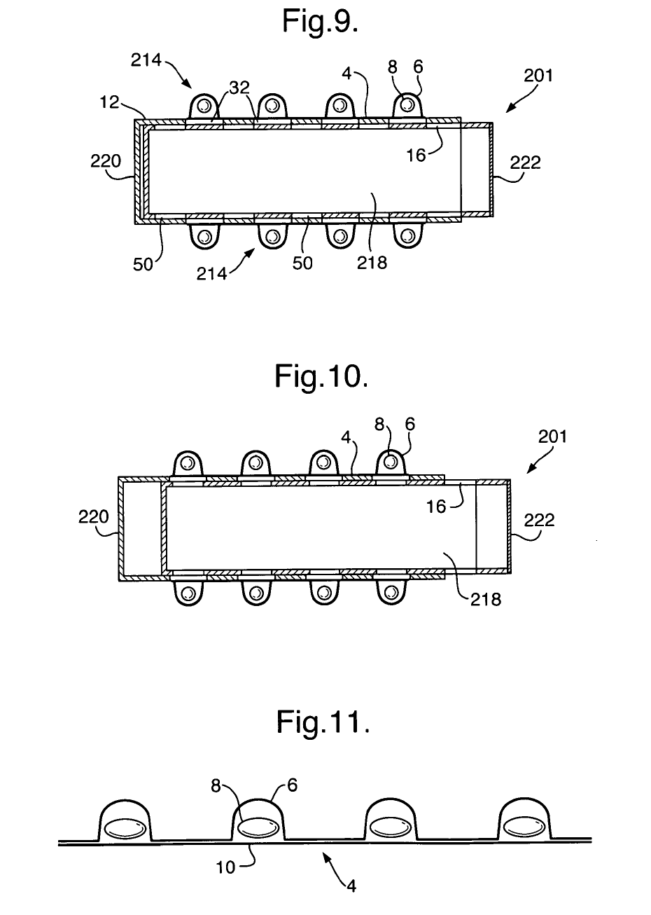

FIG. 9 shows a cross section through a further embodiment of a dispenser in a closed configuration;

FIG. 10 shows a cross section through the dispenser of FIG. 9 in an open configuration; and

FIG. 11 shows a cross section through a blister pack.

FIG. 1 shows an embodiment of a dispenser 1 in a closed configuration and FIG. 2 shows the dispenser of FIG. 1 in a partly open configuration. The dispenser 1 has a medicament carrier 2 mounted thereon, in this case the medicament carrier 2 is a blister pack 4 as shown in FIG. 11.

The blister pack 4 comprises a formed layer which is formed to include a plurality of blisters 6 within which a medicament 8 is located. The blisters 6 are raised from one side of the formed layer and form a cavity on the opposing side. The cavity is sealed with a breakable sealing layer 10. To release a medicament 8 from the blister pack a user deforms the blister 6 such that the medicament 8 is forced through the sealing layer 10.

The dispenser 1 comprises a body 12 which includes a holding portion 14 on one surface to which the blister pack 4 is secured. In this case the body 12 comprises another holding portion 14 on an opposing surface to which the blister pack 4 is secured.

The body 12 comprises and a portion of the collecting conduit 18 (described in detail with reference to FIGS. 3 and 4). The body 12 comprises the first member 20 of the dispenser 1.

The dispenser 1 further includes a second member 22 which is slidably mounted onto the first member 20 and includes a dispensing aperture 16. In this embodiment the second member 22 forms a cover which, in a closed configuration (as shown in FIG. 1) fits over the holding portions 14 of the body to prevent access thereto. The second member 22 is movable between a closed configuration and an open configuration. FIG. 2 shows the dispenser 1 in a partly open configuration in which the second member 22 has been slid from the closed position and access to at least some of the blisters 6 is possible.

The dispenser includes catches 24 on either side of the dispenser 1 which releasably retain the dispenser 1 in the closed configuration. The catches 24 comprise cooperating parts 26,28 on the first and second members 20,22. The catches 24 are released by buttons 30 which, in this case, are mounted on the second member 22, but may be mounted on the first member 20. The button 30 can form one of the cooperating parts 26,28 of the catch 24.

FIGS. 3 and 4 show cross sections through the dispenser in the configurations shown in FIGS. 1 and 2. The holding portions 14 include inlet apertures 32. An inlet aperture 32 is associated with each blister 6. The inlet apertures 32 are arranged to allow a medicament 8 released from a blister 6 to pass through the inlet aperture and into the collecting conduit 18. The collecting conduit 18 collects and stores the medicament 8 until the dispenser 1 is arranged such that medicament 8 falls under gravity to the dispensing aperture 16 from which it can be dispensed. As can be seen from the figures, medicament within the collecting conduit can only pass through the dispensing aperture 16 when the dispenser is arranged in the closed configuration as shown in FIG. 3.

In use a user would move the dispenser 1 from the closed configuration to the open configuration, or at least a partly open configuration, by pressing the buttons 30 to release the catches 24. The user then applies a force to deform the blister 6 such that the medicament 8 is forced through the breakable sealing layer 10. The blister pack 4 is supported by the holding portion 14 to facilitate a user in applying a force to the blister 6.

As the medicament 8 is released from the blister 6 it passes through an inlet aperture 32 and into the collecting conduit 18. The user can release more than one medicament 8 into the collecting conduit 18. Once the required number of medicaments 8 have been released into the collecting conduit 18 the user moves the dispenser 1 to the closed configuration and tips the dispenser 1 such that the medicaments 8 in the collecting conduit 18 fall to the dispensing aperture 16.

In this embodiment the dispenser 1 must be returned to the closed configuration after the medicament 8 has been released from the blister pack 4 in order to complete dispensing of the medicament 8 as access to the dispensing aperture 16 is restricted by the interaction of the first member 20 and second member 22 in the open configuration.

FIGS. 5 and 6 show a different embodiment of a dispenser 101 in a closed and a partly open configuration respectively. Many features function in the same way as in the dispenser 1 and will be given the same reference numeral. Where a feature is different, but functions in similar way the feature will be given a similar reference numeral incremented by 100.

The first member 120 comprises the body 112 which has a holding portion 114 to which a blister pack 4 is secured on only one side. The dispenser 101 includes two second members 122. Each second member 122 is slidably coupled to an opposing end of the first member 120 such that in a closed position the two second members 122 cooperate to substantially enclose the first member 120, thereby preventing access to the blister pack 4.

The dispenser 101 includes buttons 30 similar to those described with reference to the embodiment of a dispenser 1 shown in FIG. 1. Each button 30 is associated with a catch 24 which releasably retains the dispenser 101 in the closed configuration.

FIGS. 7 and 8 show cross sections through the dispenser in the configurations shown in FIGS. 5 and 6. It can be clearly seen that in the closed configuration, as shown in FIG. 7, the second members 122 substantially contain the first member and prevent access to the blister pack 4. Once the dispenser 101 has been moved into an open, or at least a partly open, configuration as shown in FIG. 8 the blisters 6 become accessible to a user. A user can then apply a force to the blister to release the medicament 8 therein.

A medicament 8 released from the blister pack 4 passes through the associated inlet aperture 32 and enters the collecting conduit 118. However, the medicament cannot reach the dispensing apertures 16 in the second members due to the end walls 40 of the first member 120.

The collecting conduit 118 in this embodiment includes end chambers 42 at opposing ends of the first member 120. The collecting chambers 42 are defined between the holding portion 112 and the end walls 40. The end chambers 42 include chamber outlets 44 which align with the dispensing apertures 16 only in the closed configuration. The body 122 also includes apertures 43 that allow a medicament 8 to pass from the inlet apertures 32 to the collecting chambers 42.

Thus in use a user must open the dispenser 101, release a medicament 8 from the blister pack 4 into the collecting conduit, close the dispenser 101, or at least one side thereof, so that a chamber outlet 44 and dispensing aperture 16 are aligned and the medicament can be dispensed from the dispenser 101.

It should be noted that, if desired, one, or both, end walls 40 of the first member 120 could each include one or more apertures aperture through which a medicament 8 could pass so that the dispenser 101 could dispense in the open configuration.

FIGS. 9 and 10 shows a cross section through a further embodiment of a dispenser 201 in a closed and open configuration respectively. Many features function in the same way as in the dispenser 1 and will be given the same reference numeral. Where a feature is different, but functions in similar way the feature will be given a similar reference numeral incremented by 200.

In this embodiment the second member 222 is arranged such that it is slidably mounted within the first member 220. The first member 220 comprises the body 12 which includes the holding portion 214 to which a blister pack 4 is mounted. The holding portion 214 comprises an array of inlet apertures 32 corresponding to the blisters 6 of the blister pack 4.

The second member 222 is mounted within the first member 220 and comprises an array of secondary apertures 50 which, in the open configuration as shown in FIG. 10 are aligned with the inlet apertures 32 and allow a medicament released from a blister to pass into the collecting conduit 218 and thence to the dispensing aperture 16 which is accessible only in the open configuration.

In the closed configuration as shown in FIG. 9 the secondary apertures 50 are not aligned with the array of inlet apertures 32. The second member 222 therefore substantially blocks the inlet apertures 32 and prevents a medicament 8 from being released into the collecting conduit 218.

In this embodiment the dispenser 201 is arranged such that, in the closed configuration, the breakable layer 10 of the blister pack 4 contacts the second member 222 before it breaks if the blister 6 is deformed. This arrangement maintains the environmental seal of the blister 6 until the medicament 8 is properly released.

FIG. 11 shows a details cross section of a blister pack 4. The blisters 6, medicament 8 and the breakable sealing layer 10 can be readily seen.

It should be understood that the invention has been described above by way of example only and that modification sin detail can be made without departing from the scope of the claims.

1. A dispenser for use with a medicament carrier, the medicament carrier containing at least one medicament product which can be released therefrom, the dispenser comprising a first member including a body, at least one second member comprising a dispensing aperture, the body including a holding portion for holding a medicament carrier, the holding portion including at least one inlet aperture arranged to receive a medicament released from a medicament carrier held thereon, the dispenser including a collecting conduit connecting the at least one inlet aperture and the at least one dispensing aperture, the dispenser configured such that a medicament dispensed from a medicament carrier thereon passes through the inlet aperture and into the collecting conduit from which it can be dispensed through the dispensing aperture, the first and at least one second member being slidably coupled to one another and movable between a closed configuration in which access to at least a portion of least one of the medicament carrier and dispensing aperture may be substantially hindered, or release of a medicament from the medicament carrier may be substantially hindered and a dispensing, or open, configuration, in which access to at least one of the medicament carrier and dispensing aperture or release of a medicament from the carrier is substantially not so hindered.

2. A dispenser as claimed in claim 1, in which the holding portion includes a plurality of inlet apertures.

3. A dispenser as claimed in claim 1, in which at least one inlet aperture in the holding portion is substantially blocked by the at least one second member when the closed configuration.

4. A dispenser as claimed in claim 1, in which passage through the collecting conduit between the inlet aperture and the dispensing aperture is substantially blocked when the closed configuration.

5. A dispenser as claimed in claim 1, in which the first member and at least one second member are releasably secured together in the closed position using at least one catch which must be released to move the dispenser into the dispensing position.

6. A dispenser as claimed in claim 4, in which the, or each, catch is releasable using a button associated with each catch.

7. A medication kit comprising a dispenser and at least one medicament carrier, the medicament carrier containing at least one medicament and the dispenser being as claimed in claim 1.

8. A medication kit as claimed in claim 7, in which the at least one medicament carrier is a blister pack.

9. A medication kit as claimed in claim 8, in which the blister pack comprises a plurality of blisters, each blister containing a medicament.

10. A method for dispensing a medicament from a medicament carrier attached to a holding portion of a dispenser, the dispenser comprising a first member including a body, at least one second member comprising a dispensing aperture, the body including the holding portion for holding a medicament carrier, the holding portion including at least one inlet aperture arranged to receive a medicament released from a medicament carrier held thereon, the dispenser including a collecting conduit connecting the at least one inlet aperture and the at least one dispensing aperture, the method comprising the steps of:
a. arranging the dispenser in an open configuration so that at least a portion of the medicament carrier is accessible to a user;
b. applying a force to a portion of the medicament carrier to release a medicament from the medicament carrier so the medicament passes through an inlet aperture in the holding portion;
c. using the collecting conduit to catch and retain the medicament that passes through the inlet aperture;
d. arranging the dispenser into the closed configuration so that the collecting conduit is not blocked; and
e. manipulating the dispenser so that the medicament from the collecting conduit is dispensed from the dispensing aperture.
